(19) United States
(12) Patent Application Publication
(10) Pub. No.: US 2024/0181934 A1
(43) Pub. Date: Jun. 6, 2024

(54) SYSTEM AND METHOD FOR CONTROLLING VEHICLE FUEL CELL

(71) Applicants: Hyundai Motor Company, Seoul (KR); Kia Corporation, Seoul (KR)

(72) Inventor: Kwang Chan KO, Suwon-Si (KR)

(73) Assignees: Hyundai Motor Company, Seoul (KR); Kia Corporation, Seoul (KR)

(21) Appl. No.: 18/116,725

(22) Filed: Mar. 2, 2023

(30) Foreign Application Priority Data
Dec. 1, 2022 (KR) 10-2022-0165927

(51) Int. Cl. B60L 58/30; B60L 7/10; B60L 58/12

(52) U.S. Cl. CPC B60L 58/30; B60L 7/10; B60L 58/12; B60L 2240/62; B60L 2240/642

(57) ABSTRACT

A system and a method for controlling a vehicle fuel cell includes: a gradient identification unit configured to identify a gradient range of an expected traveling route of a vehicle; and a control unit configured to control charging and discharging of a vehicle battery and a degree of power generation by a fuel cell of the vehicle in advance, before the vehicle enters the gradient range, according to whether the gradient range of the expected traveling route identified by the gradient identification unit is uphill or downhill.

### CROSS-REFERENCE TO RELATED APPLICATION(S)

The present application claims priority to Korean Patent Application No. 10-2022-0165927, filed on Dec. 1, 2022, the entire contents of which is incorporated herein for all purposes by this reference.

### BACKGROUND OF THE PRESENT DISCLOSURE

### Field of the Present Disclosure

The present disclosure relates to a system and a method for controlling a vehicle fuel cell, and more specifically, to a system and a method for controlling a vehicle fuel cell, wherein a gradient range of a vehicle is identified, and the fuel cell vehicle is controlled according to the identified gradient range, optimizing the fuel efficiency performance.

### Description of Related Art

A fuel cell vehicle includes a fuel cell for producing electrical energy through a reaction between hydrogen and oxygen, and a battery for storing the electrical energy produced by the fuel cell so that the stored electrical energy may be when necessary. The fuel cell vehicle also includes a driving motor so that electrical energy generated by regenerative braking performed by the driving motor is stored in the battery. However, there is a difference between the amount of electrical energy generated by regenerative braking by the driving motor and the amount of electrical energy produced by the fuel cell. That is, the amount in which the battery is charged by power production by the fuel cell is greater than the amount in which the battery is charged by regenerative braking by the driving motor.

When the driver requests the fuel cell vehicle to generate an output, the fuel cell and the battery generate outputs to drive the driving motor and accessories provided in the vehicle. The state of charge of the battery is considered when the fuel cell vehicle performs regenerative braking, and electrical energy generated by regenerative braking is used to charge the battery.

In the case of a large truck which is very heavy and frequently travels at a very high speed, it is difficult to supply all output necessary for vehicle traveling from the fuel cell stack. Therefore, output supplementation through power in the battery is necessary.

There are two kinds of methods for charging the battery for output supplementation.

First, when the output of the fuel cell stack is greater than output required by the vehicle, the output of the fuel cell stack may be used as the output required by the vehicle, and the remaining energy may be used to charge the battery. Energy generated by regenerative braking of the vehicle may also be used to charge the battery. The first method has a problem in that, if the amount of power generation by the fuel cell stack is increased to manage the state of charge (SOC) value of the battery, the power generation efficiency is degraded, adversely affecting the fuel efficiency. The second method has a problem in that, when the battery has already been charged, the battery cannot be charged by regenerative braking.

Accordingly, there is a demand for a scheme for managing the state of charge of the battery through regenerative braking while minimizing power generation by the fuel cell stack, securing the traveling performance of the vehicle and improving the fuel efficiency.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a system and a method for controlling a vehicle fuel cell, wherein a gradient range of a vehicle is identified, the fuel cell vehicle is controlled according to the identified gradient range, optimizing the fuel efficiency performance, energy for traveling uphill or downhill is secure, and regenerative braking of the vehicle may be maximized according to a weight estimation algorithm.

To solve the above-mentioned technical problems, the present disclosure may provide a vehicle fuel cell control system including: a gradient identification unit configured to identify a gradient range of an expected traveling route of a vehicle; and a control unit configured to control charging and discharging of a vehicle battery and a degree of power generation by a fuel cell of the vehicle in advance, before the vehicle enters the gradient range, according to whether the gradient range of the expected traveling route identified by the gradient identification unit is uphill or downhill.

For example, the gradient identification unit may identify the gradient range based on expected vehicle traveling path information with reference to a navigation map and current vehicle position information with reference to a global positioning system (GPS) sensor.

For example, the control unit may be configured to determine a weight of the vehicle during traveling of the vehicle and may control a degree of charging and discharging of the vehicle battery based on a difference between the determined weight and a curb weight of the vehicle.

For example, when the gradient range of the expected traveling route is uphill, the control unit may be configured to determine energy required by the vehicle before entering an uphill range, and may compare the determined energy required by the vehicle with energy corresponding to the dischargeable amount of the vehicle battery, controlling the degree of power generation by the fuel cell.

For example, the energy required by the vehicle may be determined through an average gradient of the uphill range and an average velocity of the vehicle.

For example, when the determined energy required by the vehicle is greater than the energy corresponding to the dischargeable amount of the vehicle battery, the control unit may be configured to control the fuel cell to generate a maximum power thereof.

For example, when the gradient range of the expected traveling route is downhill, the control unit may be configured to determine a maximum possible regenerative braking energy of the vehicle before entering a downhill range, and may compare the determined maximum possible regenerative braking energy of the vehicle with energy corresponding to a chargeable amount of the vehicle battery after uphill traveling, controlling the degree of power generation by the fuel cell.

For example, when the determined maximum possible regenerative braking energy of the vehicle is greater than the energy corresponding to the chargeable amount of the vehicle battery, the control unit may be configured to control the fuel cell to stop generating power.

For example, when the determined maximum possible regenerative braking energy of the vehicle is smaller than the energy corresponding to the chargeable amount of the vehicle battery, the control unit may be configured to control the fuel cell to optimally generate power.

For example, after the vehicle enters the downhill range, the control unit may be configured to control the degree of charging of the vehicle battery through regenerative braking.

To solve the above-mentioned technical problems, the present disclosure may provide a vehicle fuel cell control method including: identifying a gradient range of an expected traveling route of a vehicle by a gradient identification unit; and controlling the degree of charging and discharging of a vehicle battery and a degree of power generation by a fuel cell of the vehicle in advance by a control unit, before the vehicle enters the gradient range, according to whether the gradient range of the expected traveling route identified by the gradient identification unit is uphill or downhill.

For example, the controlling the degree of charging and discharging of the vehicle battery may include: determining the weight of the vehicle during vehicle traveling; and controlling a degree of charging and discharging of the vehicle battery based on a difference between the determined weight and a curb weight of the vehicle.

For example, the controlling the degree of power generation by the fuel cell may include: determining energy required by the vehicle before entering an uphill range when the gradient range of the expected traveling route is uphill; and comparing the determined energy required by the vehicle with energy corresponding to the dischargeable amount of the vehicle battery, controlling the degree of power generation by the fuel cell.

For example, the controlling the degree of power generation by the fuel cell may include: determining maximum possible regenerative braking energy of the vehicle before entering a downhill range when the gradient range of the expected traveling route is downhill; and comparing the determined maximum possible regenerative braking energy of the vehicle with energy corresponding to a chargeable amount of the vehicle battery after uphill traveling, controlling the degree of power generation by the fuel cell.

For example, the vehicle fuel cell control method may further include controlling the degree of charging of the vehicle battery through regenerative braking by the control unit after the vehicle enters the downhill range.

A system and a method for controlling a vehicle fuel cell according to an exemplary embodiment of the present disclosure are advantageous in that a gradient range of a vehicle is identified, and the fuel cell vehicle is controlled according to the identified gradient range, optimizing the fuel efficiency performance. Furthermore, energy for traveling uphill or downhill is secured, and regenerative braking of the vehicle may be maximized according to a weight estimation algorithm.

Advantageous effects obtainable from the present disclosure may not be limited to the above mentioned effects, and other effects which are not mentioned may be clearly understood, through the following descriptions, by those skilled in the art to which the present disclosure pertains.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram of a vehicle fuel cell control system according to an exemplary embodiment of the present disclosure;

FIG. 2 illustrates an equation regarding the traveling resistance of a vehicle according to an exemplary embodiment of the present disclosure;

FIG. 3 illustrates a vehicle battery control process according to a determined vehicle weight according to an exemplary embodiment of the present disclosure;

FIG. 4 illustrates a process of controlling a fuel cell and a battery when the gradient range of an expected traveling route is uphill according to an exemplary embodiment of the present disclosure; and

FIG. 5 illustrates a process of controlling a fuel cell and a battery when the gradient range of an expected traveling route is downhill according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, embodiments included in the present specification will be described in detail with reference to the accompanying drawings, and the same or similar elements are provided the same and similar reference numerals, so duplicate descriptions thereof will be omitted.

The terms “module” and “unit” used for the elements in the following description are provided or interchangeably used in consideration of only the ease of writing the specification, and do not have distinct meanings or roles by themselves.

In describing the exemplary embodiments included in the present specification, when the detailed description of the relevant known technology is determined to unnecessarily obscure the gist of the present disclosure, the detailed description may be omitted. Furthermore, the accompanying drawings are provided only for easy understanding of the exemplary embodiments included in the present specification, and the technical spirit included herein is not limited to the accompanying drawings, and it may be understood that all changes, equivalents, or substitutes thereof are included in the spirit and scope of the present disclosure. Terms including an ordinal number such as “first”, “second”, or the like may be used to describe various elements, but the elements are not limited to the terms. The above terms are used only for distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

An exemplary embodiment of the present disclosure proposes that a gradient range of a vehicle be identified, and the fuel cell vehicle be controlled according to the identified gradient range, optimizing the fuel efficiency performance.

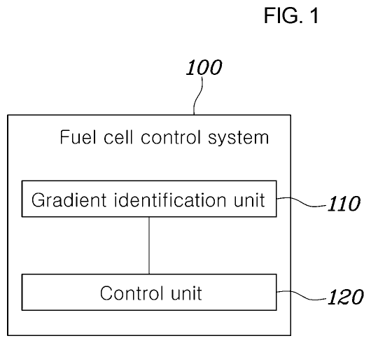

FIG. 1 is a block diagram of a vehicle fuel cell control system according to an exemplary embodiment of the present disclosure. FIG. 1 illustrates major components related to the exemplary embodiment, and it is obviously that more or less components may be included in connection with implementing an actual vehicle.

Referring to FIG. 1, the vehicle fuel cell control system 100 according to an exemplary embodiment of the present disclosure may include a gradient identification unit 110 and a control unit 120.

The gradient identification unit 110 may identify a gradient interval of an expected traveling route of the vehicle. The gradient identification unit 110 may identify the gradient range with reference to information regarding the expected traveling path of the vehicle based on a navigation map and information regarding the current position of the vehicle based on a global positioning system (GPS) sensor. The gradient identification unit 110 may receive a vehicle position signal and a speed signal from the GPS sensor, and may receive a traveling altitude on the expected traveling path from the navigation map. Accordingly, the gradient identification unit 110 can identify in real time whether a gradient range of an expected traveling route on the traveling altitude during vehicle traveling is uphill, downhill, or planar (no gradient), improving control stability of the control unit 120.

The control unit 120 may control charging and discharging of the vehicle battery and the degree of power generation by the fuel cell in advance, before the vehicle enters the gradient range, according to whether the gradient range of the expected traveling route identified by the gradient identification unit 110 is uphill or downhill. When the vehicle travels in a planar range which has no gradient with reference to GPS signals, the motor output necessary for vehicle traveling needs to be determined first and transmitted through CAN communication. Considering a constant-speed condition during a normal time, the motor output necessary for vehicle traveling may be monitored through CAN communication. When the control unit 120 determines that a gradient range exists on the expected traveling route identified by the gradient identification unit 110, the weight of the vehicle may be determined before the vehicle enters the gradient range based on the motor output necessary for vehicle traveling. This is for actively determining the regenerative braking force according to the determined weight, and the amount of recovered energy may be further increased by differently determining the regenerative braking force according to the situation. The controller 120 may be configured to determine the regenerative braking force by determining the vehicle weight also in a planar range in which no gradient range exists on the expected traveling route of the vehicle.

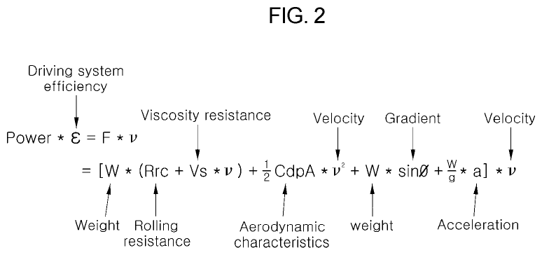

A scheme for determining the vehicle weight by the control unit 120 during traveling will be described with reference to FIG. 2.

FIG. 2 illustrates an equation regarding the traveling resistance of the vehicle according to an exemplary embodiment of the present disclosure. The friction that the vehicle needs to overcome during traveling is referred to as a traveling resistance, which includes rolling resistance, viscosity resistance, aerodynamic resistance, gradient resistance, and acceleration resistance.

Referring to FIG. 2, the motor output necessary for vehicle traveling (Power) times the driving system efficiency (ε) equals a force times a velocity. The force may be determined through weight (W), rolling resistance (Rrc), viscosity resistance (Vs), aerodynamic characteristics (Cd), front surface sectional area (A), density (ρ), gradient (Φ), and acceleration (a). When the vehicle travels at a constant speed in a planar range, the gradient and acceleration may be assumed to be zero. The motor output necessary for vehicle traveling is monitored, and the driving system efficiency is a pre-calculated value. The rolling resistance (Rrc), viscosity resistance (Vs), aerodynamic characteristics (Cd), front surface sectional area (A), and density (ρ) are determined as initial values in the vehicle development phase, and the weight (W), which is solely unknown, is determined or estimated through FIG. 2. The rolling resistance (Rrc) is a tire characteristic value and is input to a control algorithm as a constant. The viscosity resistance (Vs) is a vehicle characteristic value and is input to the control algorithm as a constant. The aerodynamic characteristics (Cd) may be input as a constant to an algorithm for controlling air density, total area, and aerodynamic constants.

After determining the vehicle weight, the controller unit 120 may control the degree of charging and discharging of the vehicle battery based on the difference between the determined weight and the curb weight. When the determined weight is smaller than 110% of the curb weight, the initially set regenerative braking force may be applied. If the determined weight is greater than the preset reference value, a larger regenerative braking force than the initially set regenerative braking force needs to be applied. The reference value may be differently set according to the vehicle setup (for example, 110% of curb weight). When the determined weight is greater than the preset reference value, a weight ratio may be applied to the regenerative braking force applied to the vehicle, which is then obtained by multiplying the initially set regenerative braking force by (estimated weight/curb weight). The higher the determined weight, the larger the regenerative braking force, and the present control scheme makes it possible to manage the state of charge of the battery and to secure vehicle traveling performance by stabilizing vehicle behavior.

Hereinafter, the way in which the control unit 120 controls charging and discharging of the vehicle battery and power generation by the fuel cell, according to whether the gradient range is uphill or downhill, will be described.

When the gradient range of the expected traveling route is uphill, the control unit 120 may be configured to determine energy required by the vehicle (PI) before entering the uphill range. Energy required by the vehicle for uphill traveling may be determined through the average gradient of the uphill range and the average velocity of the vehicle based on the equation described above. The vehicle weight W is determined as the weight during traveling on flat ground, and the gradient may be determined by dividing the current altitude with reference to the highest altitude on the expected traveling route by the distance to the highest altitude on the expected traveling route. The average velocity may be determined from a GPS signal. Based on the determined variables, the energy required by the vehicle PI for uphill traveling may be determined by multiplying the output determined through FIG. 2 by (distance to highest altitude on expected traveling route/average velocity).

The controller 120 may compare the determined energy required by the vehicle PI with energy corresponding to the dischargeable amount of the vehicle battery, controlling the degree of power generation by the fuel cell. The dischargeable amount of the vehicle battery refers to the state of charge (SOC) value of the battery when the vehicle starts uphill traveling. The energy corresponding to the dischargeable amount of the vehicle battery may be determined as nominal capacity (kWh)*(SOC value of battery when vehicle starts uphill traveling). When energy corresponding to the dischargeable amount of the vehicle battery is greater than the energy required by the vehicle PI, the control unit 120 may select a battery output mode (BEV mode) in which the vehicle travels by use of the battery output, managing the SOC value of the battery. When the energy required by the vehicle PI is greater than the energy corresponding to the dischargeable amount of the vehicle battery, the control unit 120 may control the fuel cell to generate a maximum power thereof so that the vehicle travels by use of the battery output and the fuel cell stack output.

When the gradient range of an expected traveling route is downhill, contrary to the above-mentioned situation, the control unit 120 may be configured to determine the maximum possible regenerative braking energy PD of the vehicle before the vehicle starts traveling downhill. The chargeable amount of the vehicle battery refers to (100 when vehicle starts downhill traveling)−(SOC value of battery when vehicle starts downhill traveling). The energy corresponding to chargeable amount of the vehicle battery may be determined as battery nominal capacity (kWh)*(100−SOC value of battery vehicle starts downhill traveling). The determined maximum possible regenerative braking energy of the vehicle may be compared with the energy corresponding to chargeable amount of the vehicle battery after uphill traveling, controlling the degree of power generation by the fuel cell. This may be divided into two situations.

Firstly, when the determined maximum possible regenerative braking energy PD of the vehicle is smaller than the energy corresponding to the chargeable amount of the vehicle battery, the control unit 120 may control the fuel cell to optimally generate power. The vehicle can travel uphill for a long time period solely with the remaining energy in the battery, but the target SOC value of the battery cannot be reached solely by regenerative braking during a long period of downhill traveling after a long period of uphill traveling. Therefore, to minimize the influence of the fuel cell during battery charging, the vehicle may travel uphill for a long time period through minimum stack power generation control in view of the stack power generation efficiency.

Secondly, when the determined maximum possible regenerative braking energy of the vehicle is greater than the energy corresponding to the chargeable amount of the vehicle battery, the control unit 120 may control the fuel cell to stop generating power. To maximize regenerative braking of the battery, the control unit 120 may then select a battery output mode (BEV mode) in which the vehicle travels by use of the battery output, managing the SOC value of the battery. If the vehicle starts traveling downhill thereafter, the degree of charging of the vehicle battery may be controlled through regenerative braking. In this regard, the regenerative braking force may be determined according to the type in which the control unit 120 determines the vehicle weight, as described above.

Furthermore, when the vehicle enters a planar range after traveling uphill or downhill, the control unit 120 may drive the vehicle while controlling the amount of stack power generation according to the SOC value of the battery and the output required by the vehicle as a normal fuel cell control mode.

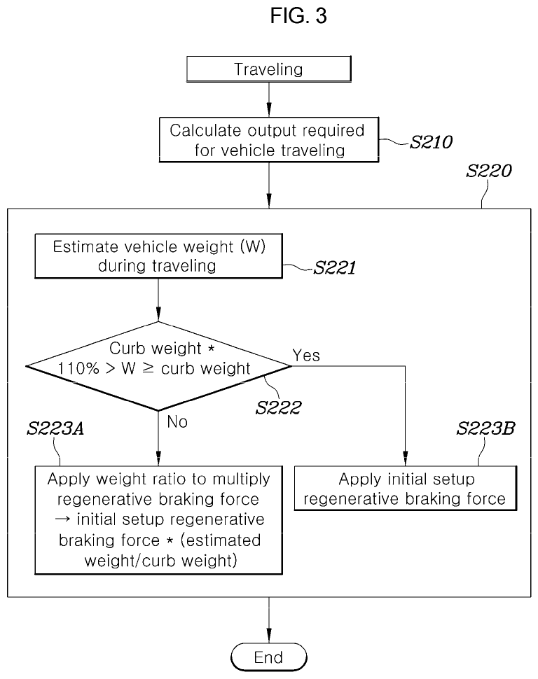

Based on the above-mentioned configuration of a vehicle fuel cell control system 100, a vehicle fuel cell control method according to an exemplary embodiment will be described with reference to FIG. 3 to FIG. 5.

FIG. 3 illustrates a vehicle battery control process according to a determined vehicle weight according to an exemplary embodiment of the present disclosure.

Referring to FIG. 3, a motor output necessary for vehicle traveling may be first monitored and determined (S210). The control unit 120 then applies a vehicle weight determination algorithm (S220). The vehicle weight (W), which is the only unknown number, may be determined or estimated with reference to FIG. 2 (S221). After determining the vehicle weight, the control unit 120 may control the degree of charging and discharging of the vehicle battery based on the difference between the determined weight and the curb weight (S222). If the determined weight is smaller than 110% of the curb weight (YES in S222), an initially set regenerative braking force may be applied (S223B). On the other hand, when the determined weight is greater than the preset reference value (NO in S222), a weight ratio may be applied so that the regenerative braking force applied to the vehicle is determined by multiplying the initially set regenerative braking force by (estimated weight/curb weight) (S223A). The higher the determined weight, the larger the applied regenerative braking force, and the present control scheme makes it possible to manage the state of charge of the battery and to secure vehicle traveling performance by stabilizing vehicle behavior.

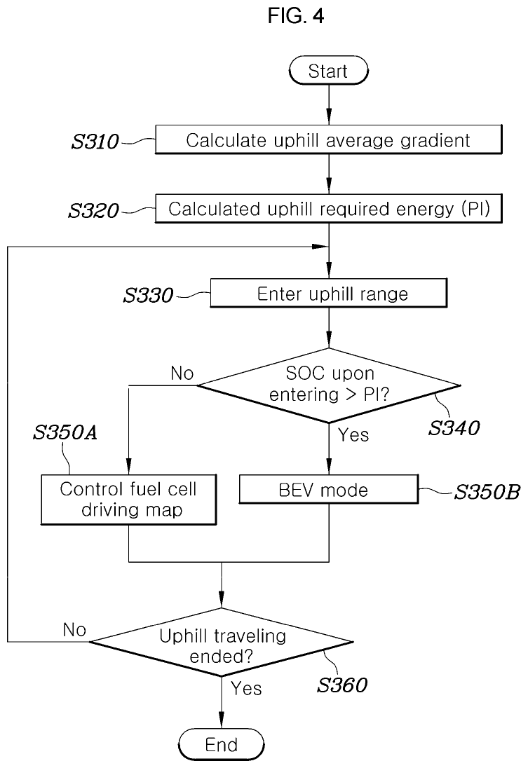

FIG. 4 illustrates a process of controlling a fuel cell and a battery when the gradient range of an expected traveling route is uphill according to an exemplary embodiment of the present disclosure.

Referring to FIG. 4, when the expected traveling route of the vehicle is uphill, the average gradient of the uphill range may be determined (S310). After determining the average gradient, the control unit 120 may be configured to determine energy required by the vehicle PI before entering the uphill range (S320). The energy required by the vehicle to travel uphill may be determined through the average gradient of the uphill range and the average velocity of the vehicle with reference to the equation in FIG. 2 described above. If the vehicle enters the uphill range (S330), the control unit 120 may compare the determined energy required by the vehicle (PI) with the magnitude of energy corresponding to the dischargeable amount of the vehicle battery, controlling the degree of power generation by the fuel cell (S340). If the energy corresponding to the dischargeable amount of the vehicle battery is greater than the energy required by the vehicle (PI) (YES in S340), the control unit 120 may select a battery output mode (BEV mode) in which the vehicle travels by use of the battery output, managing the SOC value of the battery (S350B).

On the other hand, when the energy required by the vehicle (PI) is greater than the energy corresponding to the dischargeable amount of the vehicle battery (NO in S340), the control unit 120 may control the fuel cell to generate a maximum power thereof so that the vehicle travels by use of the battery output and the fuel cell stack output (S350A).

The control unit 120 may then determine whether uphill traveling of the vehicle has ended (S360).

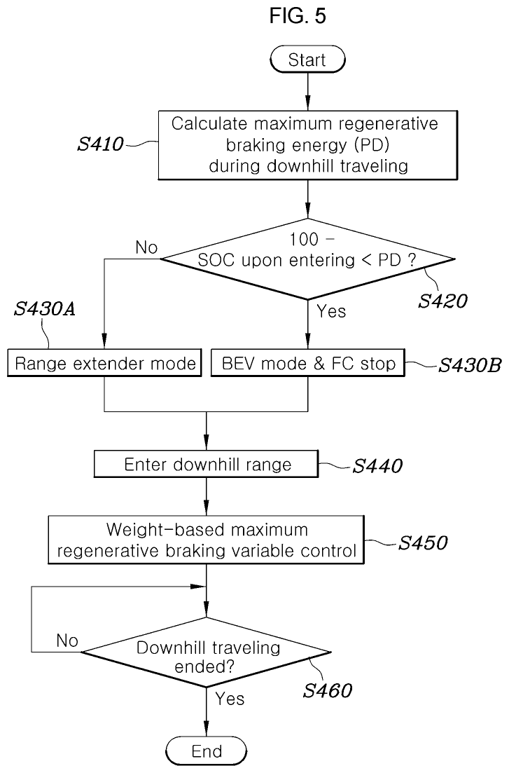

FIG. 5 illustrates a process of controlling a fuel cell and a battery when the gradient range of an expected traveling route is downhill according to an exemplary embodiment of the present disclosure.

Referring to FIG. 5, when the gradient range of an expected traveling route is downhill, the control unit 120 may be configured to determine the maximum possible regenerative braking energy PD of the vehicle before the vehicle enters the downhill range (S410). The determined maximum possible regenerative braking energy of the vehicle may be compared with energy corresponding to the chargeable amount of the vehicle battery after uphill traveling, controlling the degree of power generation by the fuel cell (S420). This may be divided into two situations.

Firstly, when the determined maximum possible regenerative braking energy PD of the vehicle is smaller than the energy corresponding to the chargeable amount of the vehicle battery (NO in S420), the control unit 120 may control the fuel cell to optimally generate power (S430A). The vehicle can travel uphill for a long time period solely with the remaining energy in the battery, but the target SOC value of the battery cannot be reached solely by regenerative braking during a long period of downhill traveling after a long period of uphill traveling. Therefore, to minimize the influence of the fuel cell during battery charging, the vehicle may travel uphill for a long time period through minimum stack power generation control in view of the stack power generation efficiency.

Secondly, when the determined maximum possible regenerative braking energy of the vehicle is greater than the energy corresponding to the chargeable amount of the vehicle battery (YES in S420), the control unit 120 may control the fuel cell to stop generating power (S430B). To maximize regenerative braking of the battery, the control unit 120 may then select a battery output mode (BEV mode) in which the vehicle travels by use of the battery output, managing the SOC value of the battery. If the vehicle starts traveling downhill thereafter (S440), the degree of charging of the vehicle battery may be controlled through regenerative braking (S450). In the present connection, the regenerative braking force may be determined according to the type in which the control unit 120 determines the vehicle weight, as described above. The control unit 120 may then determine whether downhill traveling has ended (S460).

According to various exemplary embodiments of the present disclosure described above, the gradient range of a vehicle may be identified, and the fuel cell vehicle may be controlled according to the identified gradient range, optimizing the fuel efficiency performance. Furthermore, energy necessary for uphill or downhill traveling may be secured, and regenerative braking of the vehicle may be maximized according to a weight estimation algorithm.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle fuel cell control system comprising:
a gradient identification unit configured to identify a gradient range of an expected traveling route of a vehicle; and
a control unit configured to control charging and discharging of a vehicle battery and a degree of power generation by a fuel cell of the vehicle in advance, before the vehicle enters the gradient range, according to whether the gradient range of the expected traveling route identified by the gradient identification unit is uphill or downhill.

2. The vehicle fuel cell control system of claim 1, wherein the gradient identification unit is further configured to identify the gradient range based on expected vehicle traveling path information with reference to a navigation map and current vehicle position information with reference to a global positioning system (GPS) sensor.

3. The vehicle fuel cell control system of claim 1, wherein the control unit is further configured to determine a weight of the vehicle during traveling of the vehicle and to control a degree of the charging and the discharging of the vehicle battery based on a difference between the determined weight and a curb weight of the vehicle.

4. The vehicle fuel cell control system of claim 1, wherein, when the gradient range of the expected traveling route is uphill, the control unit is further configured to determine energy required by the vehicle before entering an uphill range, and to compare the determined energy required by the vehicle with energy corresponding to a dischargeable amount of the vehicle battery, controlling the degree of power generation by the fuel cell.

5. The vehicle fuel cell control system of claim 4, wherein the energy required by the vehicle is determined through an average gradient of the uphill range and an average velocity of the vehicle.

6. The vehicle fuel cell control system of claim 4, wherein, when the determined energy required by the vehicle is greater than the energy corresponding to the dischargeable amount of the vehicle battery, the control unit is further configured to control the fuel cell to generate a maximum power thereof.

7. The vehicle fuel cell control system of claim 4, wherein, when the gradient range of the expected traveling route is downhill, the control unit is further configured to determine a maximum possible regenerative braking energy of the vehicle before entering a downhill range, and to compare the determined maximum possible regenerative braking energy of the vehicle with energy corresponding to a chargeable amount of the vehicle battery after uphill traveling, controlling the degree of power generation by the fuel cell.

8. The vehicle fuel cell control system of claim 7, wherein, when the determined maximum possible regenerative braking energy of the vehicle is greater than the energy corresponding to the chargeable amount of the vehicle battery, the control unit is further configured to control the fuel cell to stop generating power.

9. The vehicle fuel cell control system of claim 7, wherein, when the determined maximum possible regenerative braking energy of the vehicle is smaller than the energy corresponding to the chargeable amount of the vehicle battery, the control unit is further configured to control the fuel cell to optimally generate power.

10. The vehicle fuel cell control system of claim 7, wherein, after the vehicle enters the downhill range, the control unit is further configured to control a degree of the charging of the vehicle battery through regenerative braking.

11. A vehicle fuel cell control method comprising:
identifying, by a gradient identification unit, a gradient range of an expected traveling route of a vehicle; and
controlling, by a control unit, a degree of charging and discharging of a vehicle battery and a degree of power generation by a fuel cell of the vehicle in advance, before the vehicle enters a gradient range, according to whether the gradient range of the expected traveling route identified by the gradient identification unit is uphill or downhill.

12. The vehicle fuel cell control method of claim 11, wherein the gradient identification unit is configured to identify the gradient range based on expected vehicle traveling path information with reference to a navigation map and current vehicle position information with reference to a global positioning system (GPS) sensor.

13. The vehicle fuel cell control method of claim 11, wherein the controlling the degree of charging and discharging of the vehicle battery includes:
determining a weight of the vehicle during traveling of the vehicle; and
controlling the degree of the charging and the discharging of the vehicle battery based on a difference between the determined weight and a curb weight of the vehicle.

14. The vehicle fuel cell control method of claim 11, wherein the controlling the degree of power generation by the fuel cell includes:
determining energy required by the vehicle before entering an uphill range when the gradient range of the expected traveling route is uphill; and
comparing the determined energy required by the vehicle with energy corresponding to a dischargeable amount of the vehicle battery, controlling the degree of power generation by the fuel cell.

15. The vehicle fuel cell control method of claim 14, wherein the energy required by the vehicle is determined through an average gradient of the uphill range and an average velocity of the vehicle.

16. The vehicle fuel cell control method of claim 14, wherein, when the determined energy required by the vehicle is greater than the energy corresponding to the dischargeable amount of the vehicle battery, the control unit is configured to control the fuel cell to generate a maximum power thereof.

17. The vehicle fuel cell control method of claim 11, wherein the controlling the degree of power generation by the fuel cell includes:
determining a maximum possible regenerative braking energy of the vehicle before entering a downhill range when the gradient range of the expected traveling route is downhill; and
comparing the determined maximum possible regenerative braking energy of the vehicle with energy corresponding to a chargeable amount of the vehicle battery after uphill traveling, controlling the degree of power generation by the fuel cell.

18. The vehicle fuel cell control method of claim 17, wherein, when the determined maximum possible regenerative braking energy of the vehicle is greater than the energy corresponding to the chargeable amount of the vehicle battery, the control unit is configured to control the fuel cell to stop generating power.

19. The vehicle fuel cell control method of claim 17, wherein, when the determined maximum possible regenerative braking energy of the vehicle is smaller than the energy corresponding to the chargeable amount of the vehicle battery, the control unit is configured to control the fuel cell to optimally generate power.

20. The vehicle fuel cell control method of claim 11, further including:
controlling the degree of the charging of the vehicle battery through regenerative braking by the control unit after the vehicle enters a downhill range.
